(19) United States
(12) Patent Application Publication
(10) Pub. No.: US 2015/0214756 A1
(43) Pub. Date: Jul. 30, 2015

(54) CHARGING CONTROL METHOD AND APPARATUS FOR BATTERY PACK

(71) Applicant: HON HAI PRECISION INDUSTRY CO., LTD., New Taipei (TW)

(72) Inventors: CHANG-YUAN SHIH, New Taipei (TW); HSIEN-HSI JUAN, New Taipei (TW)

(21) Appl. No.: 14/584,019

(22) Filed: Dec. 29, 2014

(30) Foreign Application Priority Data
Jan. 27, 2014 (TW) 103102838

(51) Int. Cl. H02J 7/00

(52) U.S. Cl. CPC H02J 7/0021; H02J 7/007

(57) ABSTRACT

A charging control apparatus for a battery pack having a plurality of rechargeable batteries connected in series is disclosed. The charging control apparatus includes a charging unit, a current detecting unit, a voltage detecting unit, and a controlling unit. The charging unit is configured to charge the battery pack by either current constant charging or voltage constant charging. The current detecting unit is configured to detect a charging current of the battery pack in real time. The voltage detecting unit is configured to detect a voltage of each of the plurality of rechargeable batteries in real time. The controlling unit is configure to control the charging unit to switch between the current constant charging and the voltage constant charging in response to the detected charging current and the detected voltages of the plurality of rechargeable batteries. A charging control method for a battery pack is also provided.

### FIELD

The subject matter herein generally relates to a charging method for a battery pack, and particularly to a charging method that charges and protects a battery from high voltage.

### BACKGROUND

In a lithium ion rechargeable battery pack, a plurality of batteries can be connected in series to raise the output voltage. This battery pack can be fully charged by charging with constant current until a battery voltage reaches a specified voltage, then subsequently charging with a constant voltage to avoid rising the battery voltage. Since the plurality of batteries are connected in series, the same charging current flows through all the batteries. If the electrical characteristics of all the batteries connected in series are the same, the battery voltage will rise in the same manner in all the batteries. However, as the batteries degrade from repeated charging and discharging, an imbalance may develop between the electrical characteristics of each battery, because not all batteries degrade in exactly the same fashion. For batteries with unbalanced electrical characteristics, even if they are charged with the same current, voltage differences can result. As a result, a voltage of a particular battery can become particularly high and cause the battery to be detrimentally affected.

### BRIEF DESCRIPTION OF THE DRAWINGS

Implementations of the present technology will now be described, by way of example only, with reference to the attached figures.

FIG. 1 is a block diagram showing one embodiment of a charging control apparatus for a battery pack.

FIG. 2 is a graph showing voltage characteristics and current characteristics of the battery pack during charging by the charging control apparatus.

FIG. 3 is a flowchart of one embodiment of a charging control method for battery pack.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” when utilized, means “including, but not necessarily limited to”; it specifically indicates open-ended inclusion or membership in the so-described combination, group, series and the like.

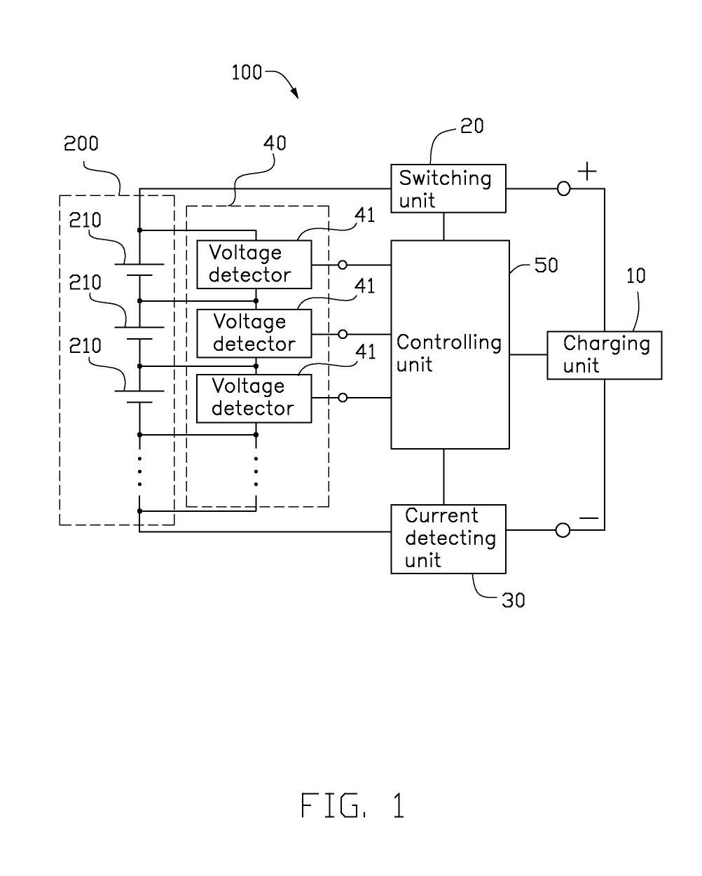

FIG. 1 is a block diagram showing one embodiment of a charging control apparatus 100 for a battery pack 200. The battery pack 200 includes a plurality of lithium ion rechargeable batteries 210 connected in series. The charging control apparatus 100 includes a charging unit 10, a switching unit 20, a current detecting unit 30, a voltage detecting unit 40, and a controlling unit 50.

The charging unit 10 is electronically coupled to the battery pack 200, and capable of charging the battery pack 200 via either constant current charging or constant voltage charging. In particular, the charging unit 10 charges the battery pack 200 with a preset constant current I1 as soon as a charging to the battery pack 200 starts. When a voltage V of one of the plurality of rechargeable batteries 210 reaches a preset voltage threshold V1, the charging unit 10 switches to charge the battery pack 200 by constant voltage charging. The term “constant voltage charging” means the charging unit 10 dynamically regulates a charging current I of the battery pack 200 to maintain the voltage V of the one of the plurality of rechargeable batteries 210 at the preset voltage threshold V1. As charging proceeds, when the charging current I of the battery pack 200 is lower than a preset current threshold 12, the charging unit 10 stops charging the battery pack 200.

The switching unit 20 is electronically coupled between the charging unit 10 and the battery pack 200. The switching unit 20 can be switched on or off under the control of the controlling unit 50 for either electronically connecting or electronically disconnecting the charging unit 10 to the battery pack 200.

The current detecting unit 30 is electronically coupled between the charging unit 10 and the battery pack 200, and configured to detect the charging current I in real time.

The voltage detecting unit 40 is electronically coupled to the battery pack 200, and configured to detect the voltage V of each rechargeable battery 210. In particular, the voltage V of each rechargeable battery 210 is a voltage difference between a positive pole and negative pole of each rechargeable battery 210, that is, a voltage drop of each rechargeable battery 210. Therefore, a voltage of the entire battery pack 200 is a sum of the voltages V of the plurality of rechargeable batteries 210. In at least one embodiment, the voltage detecting unit 40 includes a plurality of voltage detectors 41 each of which is configured detect the voltage V of one of the plurality of rechargeable batteries 210.

The controlling unit 50 is electronically coupled to the charging unit 10, the current detecting unit 30, and the voltage detecting unit 40. The controlling unit 50 can receive the charging current I from the current detecting unit 30, and the voltages V from voltage detectors 41 of the voltage detecting unit 40. The controlling unit 50 is configured to control the charging unit 10 to regulating the charging current I dynamically in response to the charging current I and the voltages V.

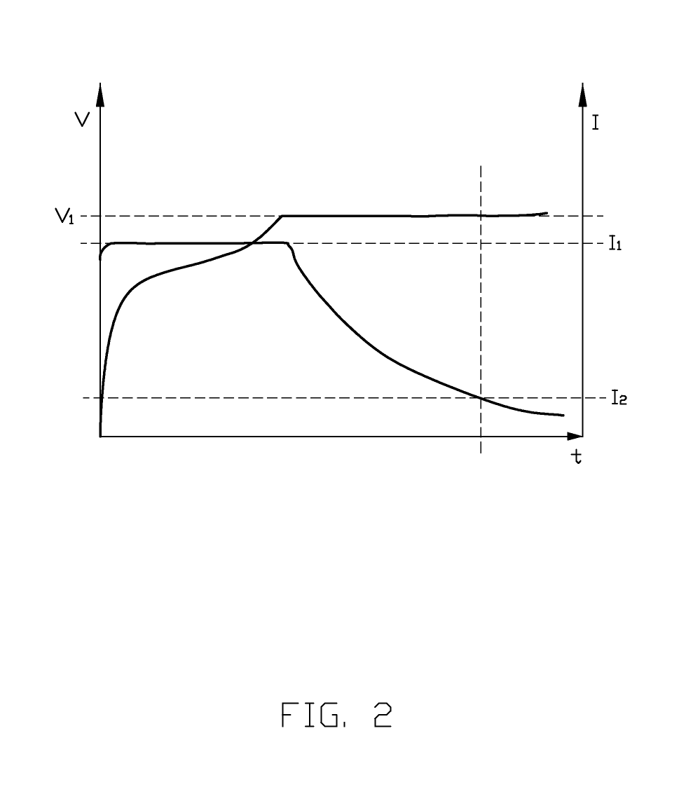

FIG. 2 illustrates a graph showing voltage characteristics and current characteristics of the battery pack 200 during charging by the charging control apparatus 100. In particular, when a charging to a discharged battery pack 200 is executed, the charging unit 10 charges the battery pack 200 with the preset constant current I1, the controlling unit 10 can control the charging unit 10 to dynamically regulating the charging current I, to maintain the charging current I at the preset constant current I1, that is the constant current charging. As the constant current charging proceeds, voltage V of each rechargeable battery 210 rise. When the voltage of one of the plurality of rechargeable batteries 210 reaches the preset voltage threshold V1, the controlling unit 10 can control the charging unit 10 to dynamically regulating the charging current I, to maintain the voltage V of the one of the plurality of rechargeable batteries 210 at the preset voltage threshold V1, that is the constant voltage charging. As the constant voltage charging proceeds, the charging current I drops gradually. When the charging current I of the battery pack 200 is lower than the preset current threshold I2, the controlling unit 50 can control the charging unit 10 to stop charging the battery pack 200. For example, in at least one embodiment, the controlling unit 50 switches the switching unit 50 off to disconnect the charging unit 10 to the battery pack 200, such that the charging process is stopped.

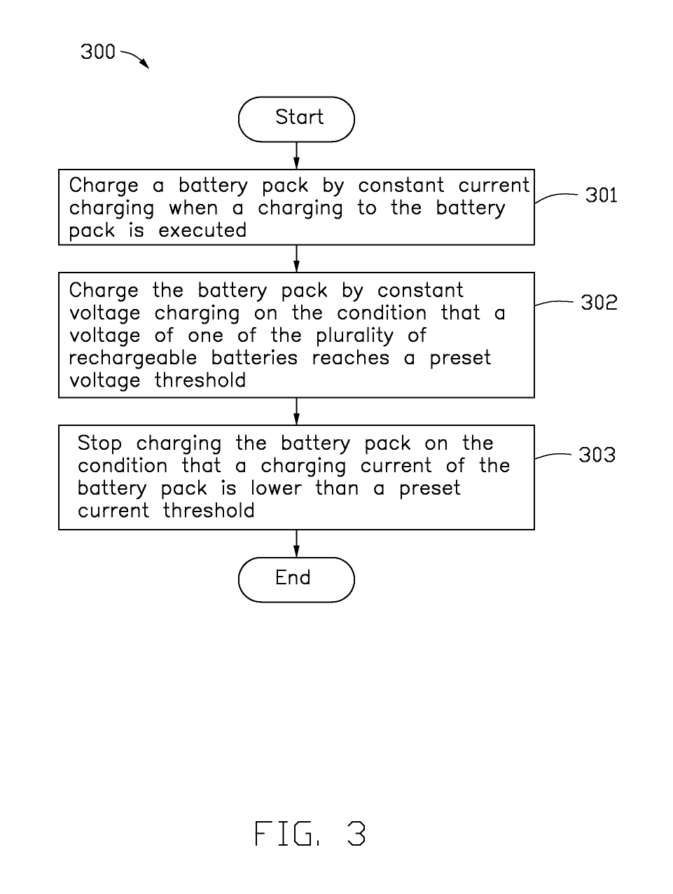

Referring to FIG. 3, a flowchart is presented in accordance with an example embodiment which is being thus illustrated. The example method 300 is provided by way of example, as there are a variety of ways to carry out the method. The method 300 described below can be carried out using the configurations illustrated in FIG. 1, for example, and various elements of these figures are referenced in explaining example method 300. Each block shown in FIG. 3 represents one or more processes, methods or subroutines, carried out in the exemplary method 300. Furthermore, the illustrated order of blocks is by example only and the order of the blocks can change according to the present disclosure. Additional blocks may be added or fewer blocks may be utilized, without departing from this disclosure. The exemplary method 300 can begin at block 301.

At block 301, the charging unit 10 charges the battery pack 200 by constant current charging. In particular, the charging unit 10 charges the battery pack 200 with the preset constant current Il when a charging to a discharged battery pack 200 is executed. The controlling unit 10 can control the charging unit 10 to dynamically regulating the charging current I, to maintain the charging current I at the preset constant current I1.

At block 302, the charging unit 10 switches to charge the battery pack 200 by constant voltage charging on the condition that a voltage V of one of the plurality of rechargeable batteries 210 reaches a preset voltage threshold V1. The term “constant voltage charging” means the charging unit 10 dynamically regulates a charging current I of the battery pack 200 to maintain the voltage V of the one of the plurality of rechargeable batteries 210 at the preset voltage threshold V1.

At block 303, the charging unit 10 stops charging the battery pack 200 on the condition that a charging current I of the battery pack 200 is lower than a preset current threshold 12.

In summary, the charging control apparatus and method utilize the charging unit 10 to charge the battery pack 200 by voltage constant charging when the voltage V of any one of the plurality of rechargeable batteries 210 reaches the preset voltage threshold V1. Accordingly, the rechargeable batteries 210 of the battery pack 200 can be protect from overvoltage when they are charged by the charging unit 10.

The embodiments shown and described above are only examples. Many details are often found in the art. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A charging control apparatus for a battery pack having a plurality of rechargeable batteries connected in series, the charging control apparatus comprising:
a charging unit configured to charge the battery pack by either current constant charging or voltage constant charging;
a current detecting unit configured to detect a charging current of the battery pack in real time;
a voltage detecting unit configured to detect a voltage of each of the plurality of rechargeable batteries in real time; and
a controlling unit electronically coupled to the current detecting unit, the voltage detecting unit and the charging unit, the controlling unit configured to control the charging unit to switch between the current constant charging and the voltage constant charging in response to the charging current and the voltages of the plurality of rechargeable batteries.

2. The charging control apparatus of claim 1, wherein when the charging unit charges the battery pack by the current constant charging, the controlling unit is configured to control the charging unit to dynamically regulating the charging current, to maintain the charging current at a preset constant current.

3. The charging control apparatus of claim 1, wherein when the voltage of one of the plurality of rechargeable batteries reaches a preset voltage threshold, the controlling unit is configured to control the charging unit to dynamically regulating the charging current, to maintain the voltage of the one of the plurality of rechargeable batteries at the preset voltage threshold.

4. The charging control apparatus of claim 1, wherein when the charging current of the battery pack is lower than a preset current threshold, the controlling unit is configured to control the charging unit to stop charging the battery pack.

5. The charging control apparatus of claim 4, further comprising a switching unit electronically coupled between the charging unit and the battery pack; wherein the switching unit is switchable between on and off under the control of the controlling unit; when the charging current of the battery pack is lower than a preset current threshold, the controlling unit controls the switching unit off to disconnect the charging unit to the battery pack.

6. A charging control method for a battery pack having a plurality of rechargeable batteries connected in series, the charging control method comprising:
charging the battery pack by constant current charging when a charging to the battery pack is executed;
charging the battery pack by constant voltage charging on the condition that a voltage of one of the plurality of rechargeable batteries reaches a preset voltage threshold; and
stopping charging the battery pack on the condition that a charging current of the battery pack is lower than a preset current threshold.

7. The charging control method of claim 6, wherein the step of charging the battery pack by constant current charging comprises:
dynamically regulating the charging current to maintain the charging current at a preset constant current.

8. The charging control method of claim 6, wherein the step of charging the battery pack by constant voltage charging comprises:
dynamically regulating the charging current to maintain the voltage of the one of the plurality of rechargeable batteries at the preset voltage threshold.
